(19) United States
(12) Patent Application Publication
(10) Pub. No.: US 2005/0105745 A1
(43) Pub. Date: May 19, 2005

(54) Dual-element speaker device

(76) Inventors: Michael O. Bowen, Boise, ID (US); Michael J. Anderson, Moscow, ID (US)

Correspondence Address: PEDERSEN & COMPANY, PLLC, P.O. BOX 2666, BOISE, ID, 83701, US

(21) Appl. No.: 10/715,343

(22) Filed: Nov. 16, 2003

(51) Int. Cl. H04R 1/02; H04R 9/06

(52) U.S. Cl. 381/89; 381/335; 381/182

(57) ABSTRACT

A practical and useful dual-element, or dual-cone, loudspeaker realizes a high efficiency of operation. Two preferably identical loudspeakers are placed back-to-back with their frontward openings facing in opposite directions, having no acoustical or mechanical connection between their movements. In the preferred embodiment, the back-to-back voice coils share a common permanent magnet. The back-to-back speaker assembly is mounted into a fixture in the center of two opposing horns, each containing an approximately 90-degree bend, approximately in the center of their lengths. The horns are acoustically independent and have approximately co-planar openings (as a result of the 90-degree corners) that project acoustical energy toward the same target. A distinct advantage due to the efficiency realized from this loudspeaker is a typical acoustical power gain of 11 dB with this approach vs. conventional speaker horn constructions. This power gain results in lower amplifier output power level requirements, hence reduced circuit costs and extended battery life in portable products.

### BACKGROUND OF THE INVENTION

1. Field of the Invention

The present invention relates generally to electro-acoustical devices, to audio loudspeakers and their enclosures, and more specifically to dual-cone speakers and their enclosures.

2. Related Art

A variety of dual-cone speaker enclosures are known in the prior art. The invention disclosed in U.S. Pat. No. 4,008,374 to Tiefenbrun discloses a bass unit for a loudspeaker system having a pair of loudspeakers mounted one behind the other in a casing to define a chamber of air. The loudspeakers are operated in concert, moving in the same direction at any instant, while the pressure of air in the chamber remains substantially constant, allowing the forward loud speaker to operate in ideal conditions. The invention in U.S. Pat. No. 4,440,260 issued to Jacobson discloses a bass reflex enclosure or cabinet, which achieves an acoustically dead front plate. In this invention, the loudspeaker unit is mounted in an opening so that an annular slot is provided around the speaker unit and utilized as a bass-reflex port arranged coaxially with the speaker unit.

The invention in U.S. Pat. No. 4,595,801 as well as those inventions in U.S. Pat. Nos. 6,343,128 B1 and 6,431,309 B1, each to Coffin, describe dual-cone speaker systems with a coupling rod between cones.

U.S. Pat. No. 6,038,326 to Czerwinski teaches a loudspeaker, which includes a compression chamber, a first electro-acoustic transducer and a horn; first electro-acoustic being disposed inside the compression chamber. The horn is mechanically and acoustically coupled to the first electro-acoustic transducer. In a separate aspect, a second electro-acoustic transducer is disposed outside the compression chamber, and is mechanically and acoustically coupled to the horn.

### SUMMARY OF THE INVENTION

Therefore it is an object of the present invention to provide a dual-element speaker that provides a higher output Sound Pressure Level (SPL) for a given audio signal level than can be realized through similar means. This increased efficiency allows application whereby the audio amplifier or driver electronics can be made with lower power components. It is another object of the present invention to provide a high SPL for purposes of alarm annunciation in security or safety related products.

What sets the present invention apart from other similar inventions and commercially available products are the following general characteristics:
a) Two identical loudspeakers are placed back-to-back with their frontward openings facing in opposite directions, the loadspeakers having no acoustical or mechanical connection between them.
b) The voice coil movements of these loudspeakers may be embodied in numerous ways, with shared or independent magnets. In the preferred embodiment, the back-to-back voice coils share a common magnet.
c) The frame that supports the loudspeaker cone may form an open or closed-basket, to either allow or disallow acoustic waves of air to pass behind the frame. In the preferred embodiment of this invention, a closed basket is used.
d) The back-to-back speaker assembly is mounted into a fixture in the center of two opposing horns, each containing a 90-degree bend, approximately in the center of their lengths. The horns are acoustically independent and have co-planar openings (as a result of the 90-degree corners) that project acoustical energy toward the same target.
e) Horn shapes, curves and sizes can be varied according to differing applications. Horn characteristics will favor a certain shape and length when the application is as an alarm annunciator, with a particularly narrow desired resonant frequency band, or the horn would have another shape and length when applied for voice or music reproduction.
f) A distinct advantage due to the efficiency realized from the present invention is a typical acoustical power gain of 11 dB with this approach vs. conventional speaker horn constructions. This power gain results in lower amplifier output power level requirements, hence reduced circuit costs and extended battery life in portable products.

As will be put forth in the following detailed description, accompanying drawings and claims, the present invention provides a practical and useful dual-element loudspeaker that realizes high efficiency of operation.

### BRIEF DESCRIPTION OF THE DRAWINGS

FIG. 1 is a cutaway top view of one embodiment of the present invention depicting the dual speaker mounting positions and internal components.

FIG. 2 is a cutaway view of a dual-horn loudspeaker of one embodiment of the present invention depicting the dual speaker mounting within a dual horn assembly.

FIG. 3 is a front, top perspective view of a dual-horn loudspeaker of one embodiment of the present invention

FIG. 4 is a top cutaway view of a preferred embodiment of the present invention depicting the two voice coils with single magnet.

FIG. 5 is a schematic wiring diagram of one embodiment of the present invention.

FIG. 6 is a schematic wiring diagram of a preferred embodiment of the present invention.

### DETAILED DESCRIPTION OF THE INVENTION

Embodiments of the present invention will now be described by way of example with reference to the accompanying drawings, in which:

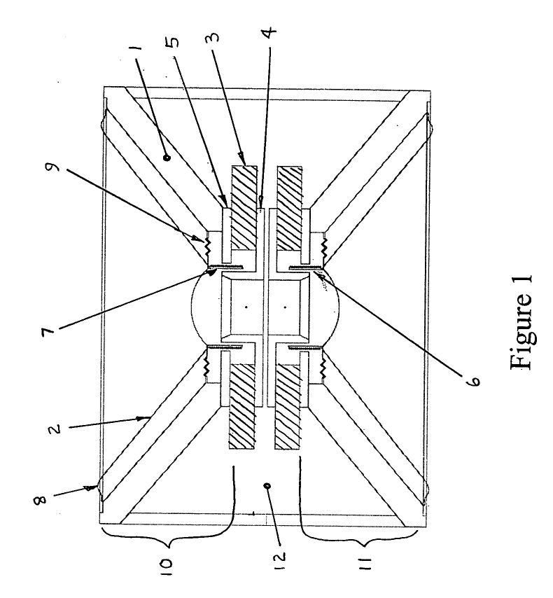

FIG. 1 is a cutaway top view of one embodiment of the present invention depicting the dual speaker mounting positions and internal components. The speaker elements 10, 11 shown are comprised of several parts. Rigid frame 1 is fabricated in the shape of a truncated cone, and in the preferred embodiment forms a solid wall that acoustically isolates the dissipative area in front of the cone 2 from causing any air movement in the area between the speaker elements 12. Cone 2 is resiliently suspended from frame 1 by a flexible surround 8 at its top, and a spider 9 at its bottom, to which cone 2 is attached.

Frame 1 is mounted to permanent magnet 3 to which pole pieces 4, 5 are attached to form magnetic field gap 6 into which voice coil 7 is placed; with the voice coil 7 attached to the base of cone 2. When voice coil 7 is energized by a signal current, electromagnetic forces in the magnetic field gap 6 cause voice coil 7 to move axially, and cone 2 to be displaced. Speaker elements 10 and 11 are preferably identical in all respects.

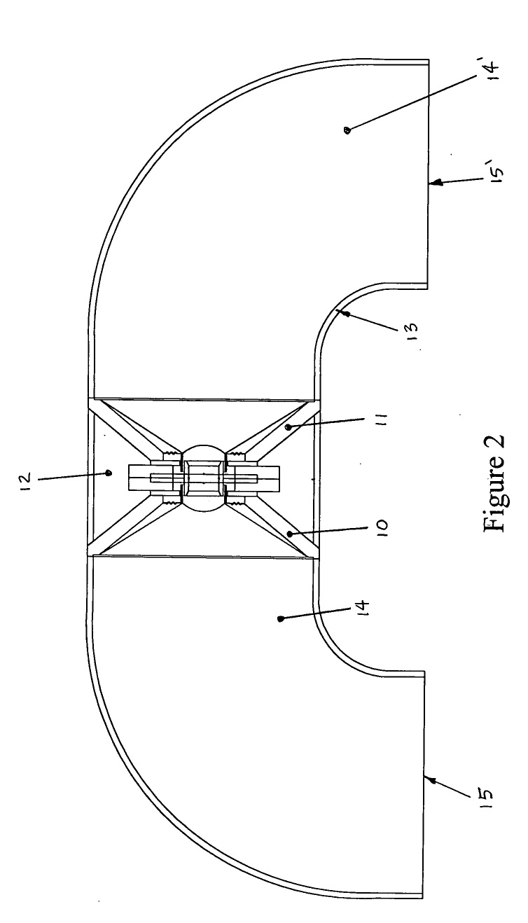

FIG. 2 is a cutaway top view of a dual-horn loudspeaker of one embodiment of the present invention depicting the preferred dual speaker mounting within a dual horn assembly. Speaker elements 10 and 11 are shown mounted back-to-back in the enclosure formed by rigid wall 13, which is shaped into two symmetrical horns 14 and 14′. These horns may be constructed using vacuum forming, injection molding, or other appropriate construction techniques. Speaker elements 10 and 11 can optionally be mounted directly back to back, or can be spaced apart.

Horns 14 and 14′ bend at approximately 90-degree angles and their openings 15 and 15′ face in the same direction. The bend radius of the approximately 90-degree curve in the preferred embodiment is approximately two inches at its center of the curve. Given this construction, sound energy emanates in a directional manner from openings 15 and 15′ in the same direction. Speaker 10 produces sound energy that is directed out of opening 15, and likewise speaker 11 produces sound energy that is directed out of opening 15′.

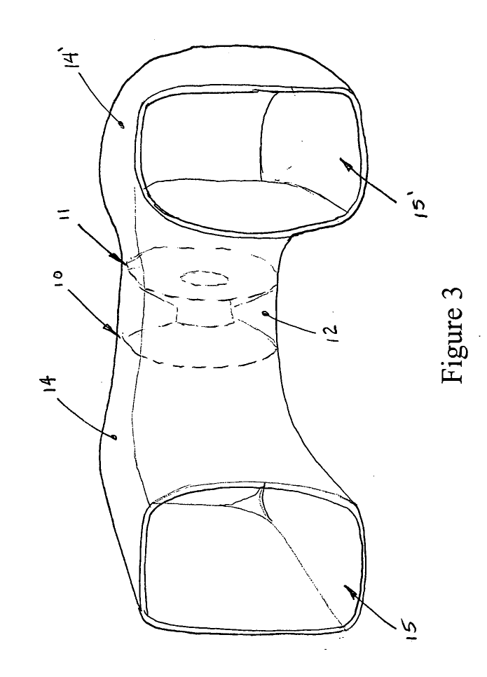

FIG. 3 is a front, top perspective view of a dual-horn loudspeaker of one embodiment of the present invention, depicting the relative shapes, symmetry and locations of horns 14 and 14′, openings 15 and 15′, and the mounting positions of speaker elements 10 and 11.

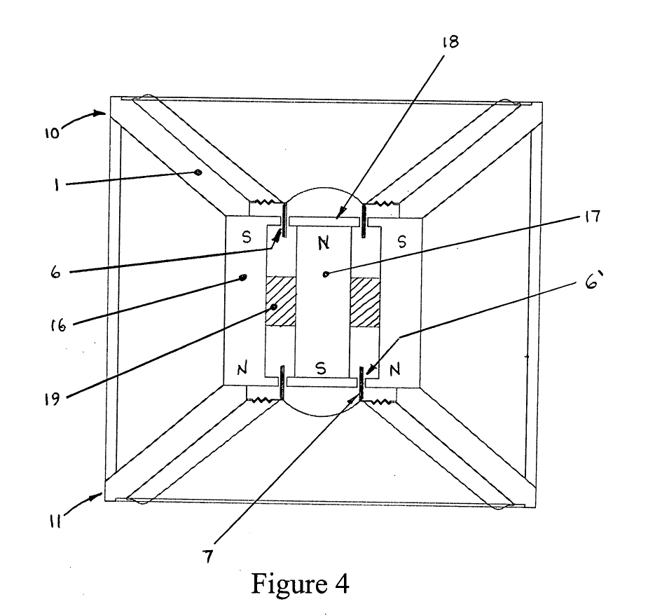

FIG. 4 is a top cutaway view of a preferred embodiment of the present invention depicting two voice coils with a single magnet. This configuration is different from that of FIG. 1 because its single magnet 17 is shared by speaker elements 10 and 11. The magnet and pole pieces 16 and 18 shape the magnetic field that crosses the flux gap at 6 and 6′. Preferably, these pole pieces are made from a ferrous material such as iron or steel. Pole piece 16 is attached to frame 1 of each speaker, and contains preferably non-ferrous spacer 19, which retains magnet 17.

The cylindrical magnet 17 of FIG. 3 replaces two ring-shaped magnets 3 in the embodiment shown in FIG. 1, thereby reducing parts count and overall manufacturing cost. It should be noted that the polarity of the magnetic fields at air gaps of speaker elements 10 and 11 will be opposite when using a single magnet in this manner, as compared to the fields having the same orientation in the case of independent speakers, made in identical fashion to each other, using ring magnets.

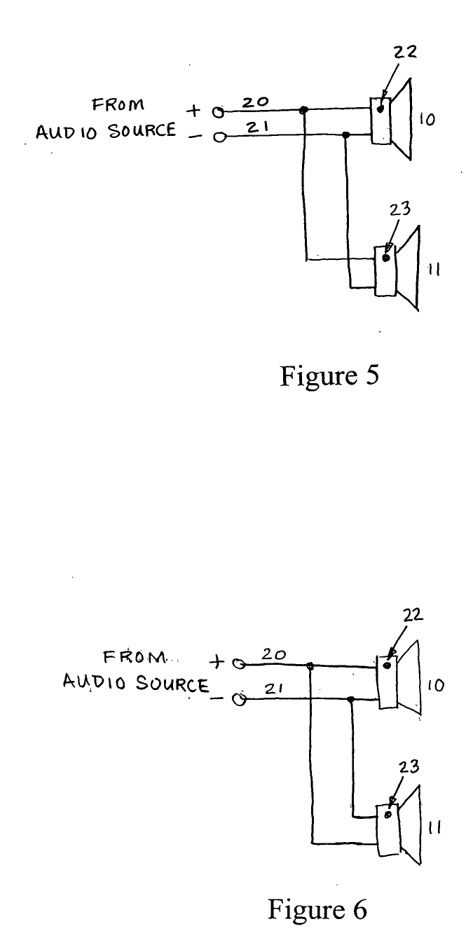

FIG. 5 is a schematic wiring diagram of one embodiment of the present invention. Such a wiring scheme would be used for a set of speakers with identical polarity magnetic air gaps such as the one depicted in FIG. 1. Note that the positive polarity connection 20 connects to each speaker elements 10 and 11 at polarizing dots 22 and 23, as are typically found stamped at the connection point of commercially available speaker elements. The negative polarity connection 21 connects to each speaker element 10 and 11 at the un-marked connection point.

FIG. 6 is a wiring diagram of a preferred embodiment of the present invention. This wiring scheme would be used for a set of speakers with opposite polarity magnetic air gaps such as the preferred embodiment, as depicted in FIG. 4. Note that the positive polarity connection 20 connects to speaker element 10 at polarizing dot 22, and connects to speaker element 11 at the opposite, un-marked connection point. Conversely, the negative polarity connection 21 connects to speaker element 10 at the un-marked connection point and connects to speaker element 11 at polarizing dot 23.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. A dual-cone loudspeaker, comprising:
a. Two speaker elements, facing in opposite directions; and
b. Two acoustical horns, each containing an approximately 90-degree bend; said horns being acoustically independent and having approximately co-planar openings that project acoustical energy in the same direction;
c. Said two speaker elements each being located within one of said two acoustical horns.

2. The dual-cone loudspeaker of claim 1, further comprising a single, shared magnet between the two speaker elements.

3. The dual-cone loudspeaker of claim 1, further comprising two separate magnets; one for each speaker element.

4. A dual-cone loudspeaker, comprising:
a. Two speaker elements, facing in opposite directions, each having a closed basket or frame behind their respective speaker cones, and
b. Two acoustical horns, each containing an approximately 90-degree bend; said horns being acoustically independent and having approximately co-planar openings that project acoustical energy in the same direction;
c. Said two speaker elements each being located within one of said two acoustical horns.

5. The dual-cone loudspeaker of claim 4, further comprising a single, shared magnet between the two speaker elements.

6. The dual-cone loudspeaker of claim 4, further comprising two separate magnets; one for each speaker element.
